(19) United States
(12) Patent Application Publication
(10) Pub. No.: US 2003/0071453 A1
(43) Pub. Date: Apr. 17, 2003

(54) Tensioner-proof closure for a safety belt

(75) Inventor: Volker Holzapfel, St. Wendel (DE)

Correspondence Address: TAROLLI, SUNDHEIM, COVELL,, TUMMINO & SZABO L.L.P., 1111 LEADER BLDG., 526 SUPERIOR AVENUE, CLEVELAND, OH, 44114-1400, US

(73) Assignee: TRW Occupant Restraint Systems GmbH & Co. KG

(21) Appl. No.: 10/271,142

(22) Filed: Oct. 15, 2002

(30) Foreign Application Priority Data
Oct. 16, 2001 (DE) 201 16 939.8

(51) Int. Cl. B60R 22/00

(52) U.S. Cl. 280/801.1

(57) ABSTRACT

A closure for a safety belt comprises a frame and at least one locking element which is pivotally mounted in its center of gravity to the frame such that it is movable between a locking position and a release position. The closure further comprises at least one spring which urges the locking element into the locking position. An actuating opening is provided which enables direct access to the locking element.

### TECHNICAL FIELD

This invention relates to a closure for a safety belt.

### BACKGROUND OF THE INVENTION

Conventional closures comprise a frame, at least one locking element which is pivotally mounted in its center of gravity to the frame such that it is movable between a locking position and a release position, and at least one spring which urges the locking member into the locking position. In accordance with the prior art, safety belt systems frequently are only firmly mounted to the intended anchor points when most of the other components have already been incorporated in the passenger cell. This always involves a considerable effort both during assembly and disassembly of the safety belt system. Improvements are provided by safety belt systems in which suitable components of the safety belt system are first mounted each at defined parts of the passenger cell. These components of the safety belt system can have a closure or a corresponding counterpart. The final assembly of the entire safety belt system then is effected such that the closures and their respective counterparts are joined. In this way, e.g. an end fitting can be connected with the remaining components of a safety belt system.

It is the object of the invention to provide a closure for a safety belt, which offers a simple possibility for locking and unlocking and in which the locking element takes a safe locking position.

### BRIEF SUMMARY OF THE INVENTION

According to the invention, a closure for a safety belt comprises a frame and at least one locking element which is pivotally mounted in its center of gravity at the frame such that it is movable between a locking position and a release position. The closure further comprises at least one spring which urges the locking element into the locking position. An actuating opening is provided which enables direct access to the locking element. In contrast to a conventional belt buckle it is not possible in the closure, according to the invention, for a safety belt to switch from the locking position to the release position by means of a simple release button. Rather, it is necessary to introduce an actuating element into the actuating opening, in order to move the locking element from the locking position into the release position. When the closure, according to the invention, for a safety belt is provided as connecting element for an end fitting, considerable mounting advantages can be achieved therewith. It is thus possible to mount an end fitting tensioner together with the end fitting to a first place, e.g. to the seat, while the remaining parts of the safety belt are attached to a second place, e.g. to the B-pillar. Thus, both the assembly of the individual components and the joining of the individual components in the final assembly can be effected at different times in different places.

It is particularly advantageous when, in the locking position, the locking element can lock an insertion tongue into place at the frame. The various parts of the safety belt system can then be preassembled at various places each with a closure or an insertion tongue and need finally only be put together.

Advantageous aspects of the invention can be taken from the sub-claims.

### BRIEF DESCRIPTION OF THE DRAWINGS

FIG. 1 shows an exploded view of a first embodiment of a closure, according to the invention, for a safety belt;

FIG. 1a shows a sectional view of the first embodiment of a closure, according to the invention, for a safety belt;

FIG. 2 shows a sectional view of a second embodiment of the closure, according to the invention, for a safety belt;

FIG. 2a shows the second embodiment of the closure, according to the invention, for a safety belt in a side view;

FIG. 3 shows a sectional view of a third embodiment of the closure, according to the invention, for a safety belt;

FIG. 4 shows a sectional view of a detail of the third embodiment of the closure, according to the invention, of a safety belt in a release position;

FIG. 4a shows a detailed view of the third embodiment of the locking element of the closure, according to the invention, of a safety belt in a locking position;

FIG. 5a shows a sectional view of a detail of the third embodiment of the closure, according to the invention, of a safety belt with partly inserted insertion tongue;

FIG. 5b shows a further sectional view of a detail of the third embodiment of the closure, according to the invention, of a safety belt with inserted insertion tongue and open rotary latch; and

FIG. 5c shows a further sectional view of a detail of the third embodiment of the closure, according to the invention, of a safety belt in the locking position.

### DETAILED DESCRIPTION OF THE PREFERRED EMBODIMENTS

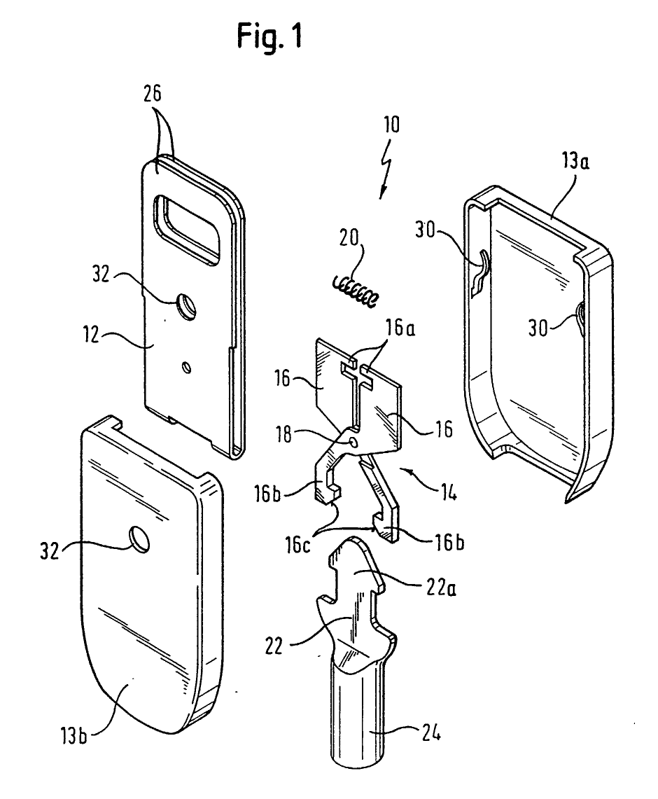

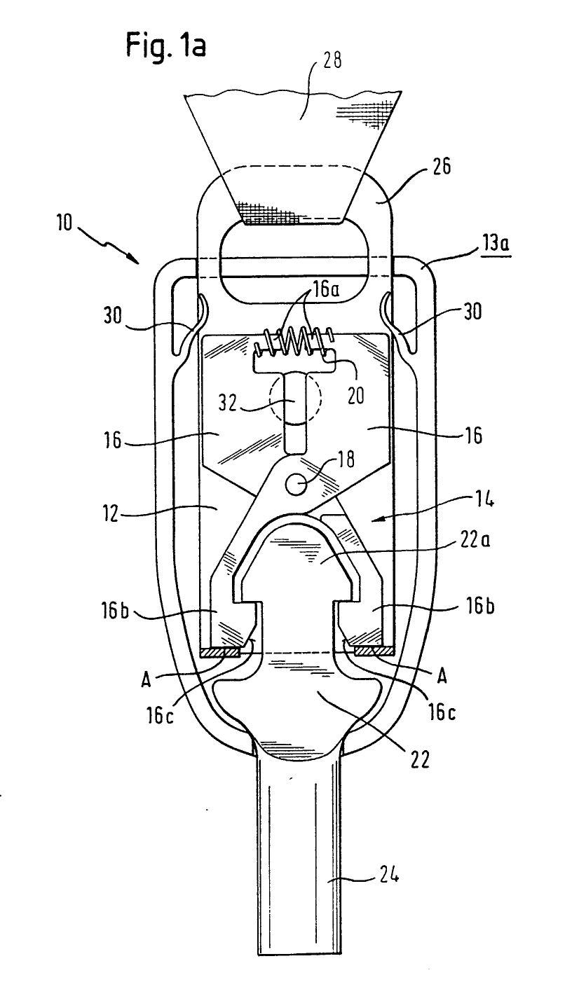

FIGS. 1 and 1a show a closure 10 according to the invention and comprising a frame 12, which has a common, substantially circular actuating opening 32, and a locking element 14, which is accommodated in the frame. The locking element 14 is composed of two symmetric tongs elements 16 which are connected with each other in a common first pivot 18. With respect to the Figures, each tongs element 16 has a centering pin 16a at the top and a tongs jaw 16b at the bottom. At their lower end with respect to the Figures, the tongs jaws 16b each have a chamfer 16c. The centering pins 16a and the tongs jaws 16b each directly oppose each other in pairs in the locking element 14. The tongs elements 16 are components of a simple geometry and provide for a compact design of the locking element. A spring designed as tension spring 20 is in engagement with the centering pins 16a and exerts such a force on the two tongs elements 16 that the two tongs jaws 16b are urged against each other. At the end of the frame 12 opposite the tongs jaws 16b a lug 26 is formed, with a belt webbing 28 extending through this lug.

In the lower region of the tongs elements 16 with respect to the Figures, an insertion tongue 22 is located between the tongs jaws 16b. This insertion tongue has an expanded insertion tongue head 22a which is enclosed by the two tongs jaws 16b such that the insertion tongue 22 is retained in the closure 10 with little clearance. At the lower end of the insertion tongue 22 with respect to the Figures, a pressed sleeve 24 is formed on in one piece, to which sleeve an end fitting tensioner (not shown) is connected via a cable (not shown). Mounted to the frame 12 are two covering elements 13a, 13b which protect the closure to the outside. For guiding the tongs elements 16, two injection-molded guiding springs 30 are provided in the interior of the covering element 13a. The covering element 13b as well as the frame 12 are provided with the actuating opening 32.

For opening the connection between closure and insertion tongue, an actuating element (not shown) is introduced into the actuating opening 32 at right angles to the image plane. By rotating this actuating element, the tongs elements 16 are urged apart. As actuating element, a commercially available screwdriver for slotted screws can be used, for instance. In so doing, the minimum distance between the tongs jaws 16b is increased beyond the maximum width of the insertion tongue head 22a to such an extent that the insertion tongue 22 is released. For connecting the closure 10 with the insertion tongue 22, the latter is inserted into the locking element 14, the insertion tongue head 22a initially resting against the chamfers 16c of the tongs jaws 16b. During the further insertion of the insertion tongue 22, the tongs jaws 16b are then urged apart until the insertion tongue head 22a can finally slide through between the two tongs jaws 16b into the locking element 14, whereupon these tongs jaws snap back into their position shown in FIG. 1a due to the spring force of the spring 20.

Under load, force is transmitted from the cylinder tube 24 via the insertion tongue 22 to the tongs elements 16. In the region A, the tongs jaws 16b are supported on the frame 12. From the frame 12, the force is transmitted to the belt webbing 28 via the lug 26. Since the tongs elements 16 are symmetric and the common first pivot 18 is the center of gravity, they exhibit an acceleration-neutral behavior.

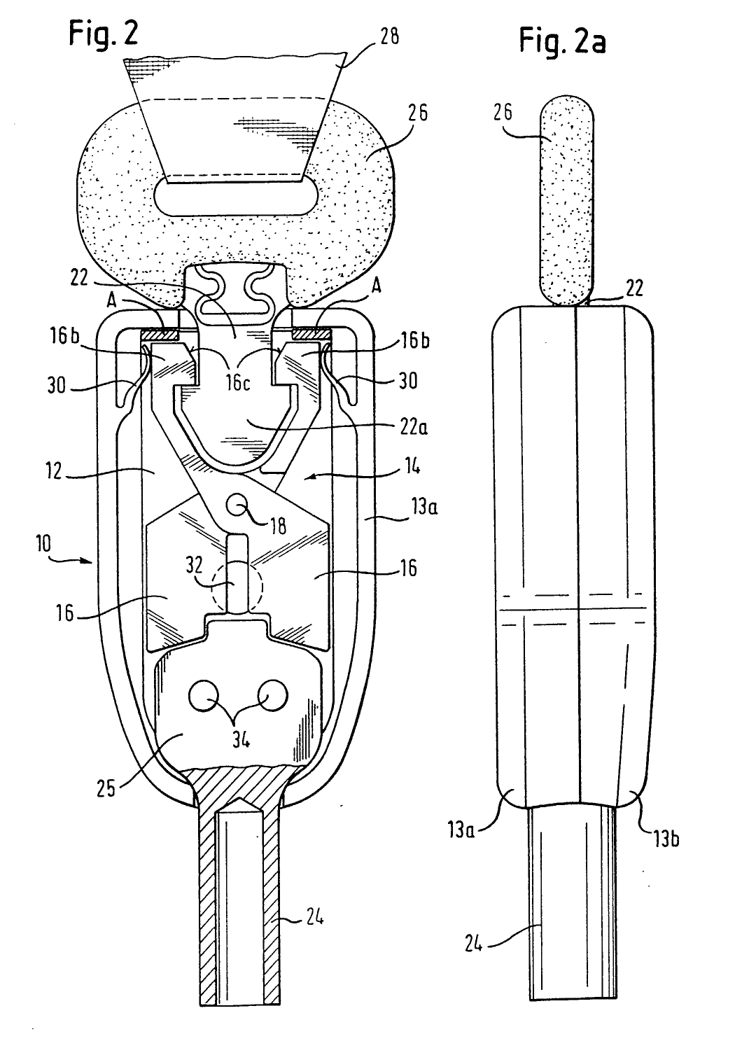

FIGS. 2 and 2a represent a second embodiment of the closure 10 for a safety belt. In the frame 12 with the actuating opening 32, the locking element 14 with the tongs elements 16 is mounted. The tongs elements have tongs jaws 16b with chamfers 16c and are connected with each other in the first pivot 18. Injection-molded guiding springs 30 which are provided in the interior of the covering element 13a exert a force on the tongs jaws 16b, so that the latter are compressed without further springs having to be used. In the locking element 14, the insertion tongue 22 is mounted at the top with respect to the Figures. This insertion tongue is attached to the lug 26 holding the belt webbing 28. A plate element 25 is integrally formed on the cylinder tube 24, which plate element is attached to the frame 12 by means of two rivets 34 at the bottom with respect to the Figures. At the frame 12, two covering elements 13a, 13b are furthermore arranged, which protect the closure to the outside.

Closure 10 and insertion tongue 22 are separated from each other in that via the actuating opening 32 the locking element 14 is opened by means of an actuating element, e.g. a screwdriver for slotted screws, against the compressive force of the guiding springs 30 to such an extent that the insertion tongue head 22a between the tongs jaws 16b is pushed out of the locking element and the insertion tongue 22 can thus be released.

Connecting the closure with the insertion tongue is effected as described for the first embodiment and will therefore not be set forth here in greater detail.

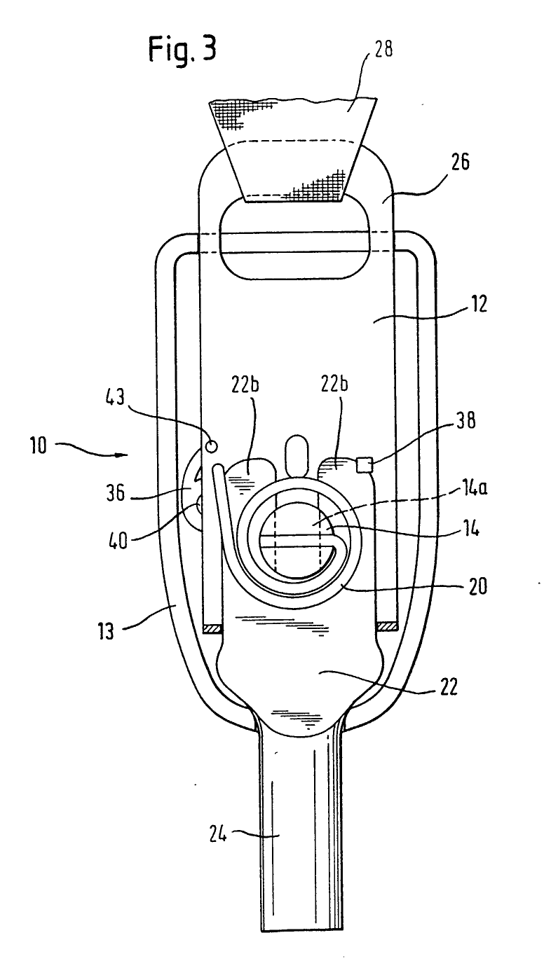

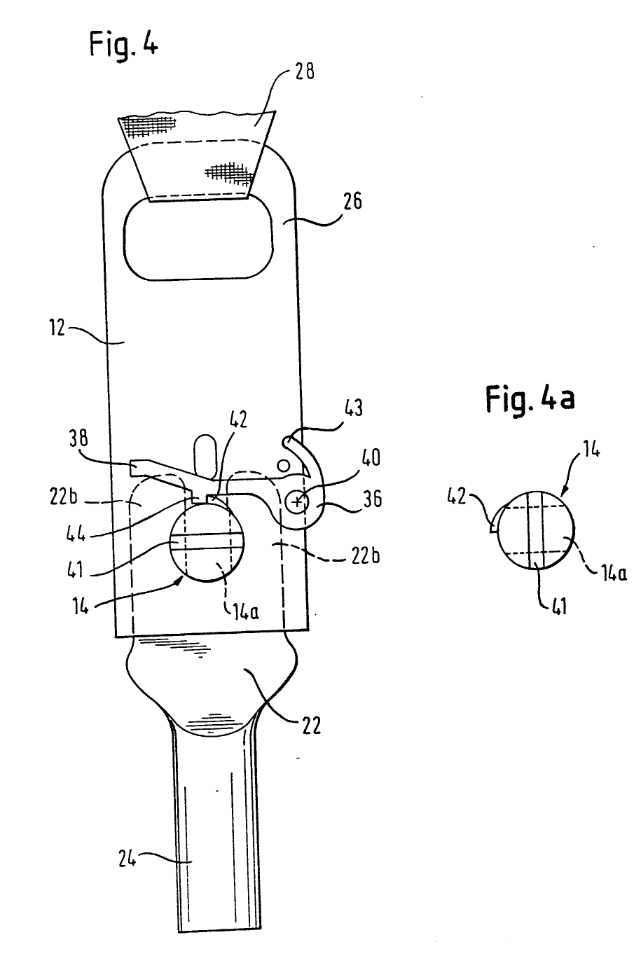

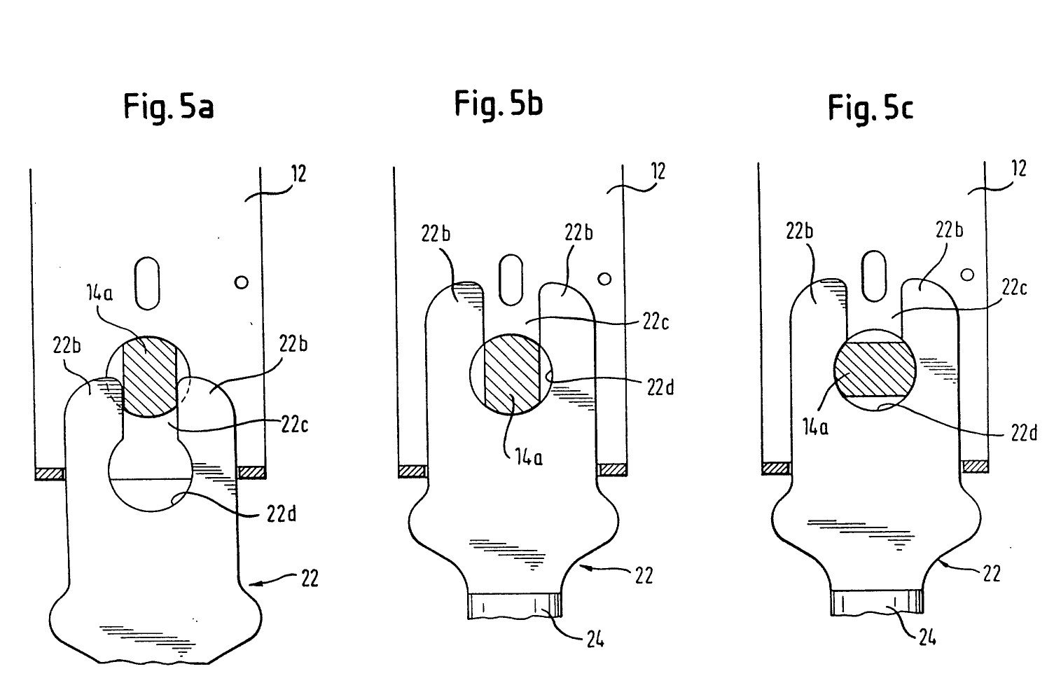

FIGS. 3, 4, 4a and 5a to 5c represent sectional views of a third embodiment of the closure, according to the invention, for a safety belt. In the frame 12, the locking element 14 is mounted, which here has a particularly space-saving design as a rotary latch and has a closing pin 14a. The locking element 14 is biased by the spring 20, which here constitutes a torsion spring. In the frame 12, there is furthermore disposed a restraining element 36 with an actuating pin 38. The restraining element 36 is pivotally mounted on the frame 12 in a second pivot 40. The restraining element 36 in addition has a spring lug 43, which is supported on the frame and designed and dimensioned such that it urges the restraining element around the pivot 40 in anti-clockwise direction with respect to FIG. 4. In the frame 12, there is furthermore provided the insertion tongue 22, which has a circular recess 22d, two wings 22b and a tongue gap 22c (FIGS. 5a-5c). The diameter of the recess 22d is equal to the maximum length of the closing pin 14a, and the width of the gap 22c corresponds to the width of the closing pin. Connected to the insertion tongue is the cylinder tube 24, from which a cable (not shown) extends to the end fitting tensioner. Formed on the end of the frame 12 opposite the cylinder tube 24 is the lug 26, to which the belt webbing 28 is attached.

In FIG. 4, the insertion tongue 22 connected with the cylinder tube 24 has been introduced into the closure, and the locking element 14, which has a slot 41 and a tooth element 42, is in a release position. The tooth element 42 cooperates with a projection 44 of the restraining element 36. In FIG. 4a, the locking element 14 of the closure, according to the invention, of a safety belt is in the locking position.

FIGS. 5a to 5c show the closure 10 with partly inserted insertion tongue 22 (FIG. 5a), with inserted insertion tongue and open rotary latch 14 (FIG. 5b) as well as with the insertion tongue locked into place at the frame 12 (FIG. 5c).

In the following, the mode of function of the third embodiment of the closure will be represented. In FIG. 5a, the insertion tongue 22 has been partly inserted into the frame 12, and the rotary latch 14 is in a release position. The insertion tongue can be inserted into the frame 12 further upwards with respect to the Figures, the closing pin 14a being moved relative to the insertion tongue in the tongue gap 22c. In FIGS. 3 and 5b, the insertion tongue 22 has been introduced into the closure almost completely, and the closing pin 14a almost completely lies within the circular recess 22d. The (with respect to FIG. 3) right wing 22b of the insertion tongue 22 now abuts at the actuating pin 38 and during the further movement of the insertion tongue moves this actuating pin to the top with respect to the Figures such that the projection 44 of the restraining element 36 gets out of engagement with the tooth element 42 of the locking element 14. The locking element 14 biased by the torsion spring 20 is thus released. At this time, the closing pin 14a already completely lies inside the recess 22d, so that the locking element 14 can rotate by 90° in anti-clockwise direction with respect to FIG. 4 into the locking position. The locking element 14 with the closing pin 14a thus reaches a position as it is shown in FIGS. 4a and 5c. The closing pin 14a now is in engagement with the recess 22d of the insertion tongue 22 such that the same can no longer be withdrawn from the frame 12. The absorption of load is effected from the pressed sleeve 24 via the insertion tongue 22, the locking element 14 mounted in the frame 12, onto the lug 26 into which the belt webbing is sewn.

If the closure 10 and the insertion tongue 22 must be separated from each other, the closing pin 14a can be rotated by 90° in clockwise direction with respect to FIG. 4a by means of an actuating element which can be introduced into the actuating opening 32 and into the slot 41. The closing pin 14a then reaches the position in the recess 22d as shown in FIG. 5b, whereby the insertion tongue 22 is released and can be withdrawn from the frame 12. In so doing, the restraining element 36 is swiveled downwards with respect to FIGS. 3 and 4, whereby the projection 44 gets in engagement with the tooth element 42 of the locking element 14. The spring 20 then again holds the locking element 14 in its biased position, until the insertion tongue is newly introduced.

1. A closure for a safety belt, said closure comprising a frame, at least one locking element which is pivotally mounted in its center of gravity on said frame such that it is movable between a locking position and a release position, and at least one spring which urges said locking element into said locking position, said closure comprising an actuating opening which provides for direct access to said locking element.

2. The closure for a safety belt as claimed in claim 1, wherein in said locking position said locking element can lock an insertion tongue into place at said frame.

3. The closure for a safety belt as claimed in claim 1, wherein said locking element comprises two tongs elements.

4. The closure for a safety belt as claimed in claim 1, wherein said spring is a tension spring.

5. The closure for a safety belt as claimed in claim 1, wherein said spring comprises two guiding springs.

6. The closure for a safety belt as claimed in claim 3, wherein said tongs elements are connected with each other in a common first pivot.

7. The closure for a safety belt as claimed in claim 1, wherein said locking element is a rotary latch.

8. The closure for a safety belt as claimed in claim 7, wherein said spring is a torsion spring.

9. The closure for a safety belt as claimed in claim 8, wherein said closure comprises a restraining element which holds said locking element in its release position when said insertion tongue is not locked into place at said frame.

10. The closure for a safety belt as claimed in claim 1, wherein an actuating element is provided which is embodied as a screwdriver for slotted screws.
